(19) United States
(12) Patent Application Publication
(10) Pub. No.: US 2008/0298293 A1
(43) Pub. Date: Dec. 4, 2008

(54) PEER-TO-PEER GROUP CALL SUPPORT IN A COMMUNICATION SYSTEM

(75) Inventors: Bradley M. Hiben, Glen Ellyn, IL (US); Bob D. Logalbo, Rolling Meadows, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/754,488

(22) Filed: May 29, 2007

(51) Int. Cl. H04J 3/24

(52) U.S. Cl. 370/312

(57) ABSTRACT

A method for supporting telecommunications over a wide area network. The method can include receiving telecommunications content and a group identifier from a first remote unit (104). From the group identifier, a plurality of recipient identifiers can be identified. The telecommunications content and the plurality of recipient identifiers can be communicated to a packet duplicator (150). Each of the recipient identifiers can be associated with at least one intended recipient (106, 108) of the telecommunications content. The telecommunications content then can be communicated via at least one peer-to-peer communications link to a plurality of telecommunications stewards (136, 138). Each of the telecommunications stewards can be associated with at least one respective recipient identified by at least one of the recipient identifiers.

### BACKGROUND OF THE INVENTION

1. Field of the Invention

The present invention generally relates to communications over a wide area network and, more particularly, to telecommunications.

2. Background of the Invention

Multi-site land mobile radio systems are well known. They are primarily utilized to provide emergency communications to police officers, fire fighters and other emergency responders. These systems typically utilize leased communication lines to interconnect radio repeater sites with a central call control server. The recurring costs of the leased communication lines, as well as the capital investment required for the radio repeater sites and specialized call control server, result in relatively high system costs. Accordingly, these systems are typically exclusively owned and operated by governmental agencies.

Professional and commercial entities, such as retail chains, school systems and construction companies, also may benefit from the use of multi-site land mobile radio systems but, due to the recurring costs and the required capital investment, generally do not deploy such systems. Indeed, companies who operate over large geographic areas or in different regions may require hundreds or even thousands of radio repeater sites to implement a suitable multi-site land mobile radio system. Moreover, such a system would require multiple central call servers, which themselves would need to be connected over leased lines, thus creating significant additional operational expenses.

### SUMMARY OF THE INVENTION

The present invention relates to a method for supporting telecommunications over a wide area network. The method can include receiving telecommunications content and a group identifier from a first remote unit and communicating the telecommunications content to a packet duplicator. A plurality of recipient identifiers also can be communicated to the packet duplicator. Each of the recipient identifiers can be associated with at least one recipient of the telecommunications content. The telecommunications content then can be communicated via at least one peer-to-peer communications link to a plurality of telecommunications stewards. Each of the telecommunications stewards can be associated with at least one respective recipient identified by at least one of the recipient identifiers.

In another arrangement the method can include, at a telecommunications steward associated with a second communications site, receiving telecommunications content and an identifier associated with a second remote unit from a first communications site. Such telecommunications content can be generated by a first remote unit. The method also can include identifying a third communications site at which a second remote unit has established its presence. The telecommunications content can be forwarded via at least one peer-to-peer communications link to a telecommunications envoy associated with the third communications site at which a second remote unit has established its presence.

The present invention also relates to a system that supports telecommunications over a wide area network. The system can include a first telecommunications steward that receives telecommunications content and a group identifier from a first remote unit. The system also can include a packet duplicator to which the first telecommunications steward communicates the telecommunications content and the plurality of recipient identifiers. The packet duplicator can forward the telecommunications content via at least one peer-to-peer communications link to a plurality of additional telecommunications stewards, each of which are associated with at least one respective recipient identified by at least one of the recipient identifiers.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a half duplex signaling flow diagram that is useful for understanding the present invention; and

FIG. 3 depicts a full duplex signaling flow diagram that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

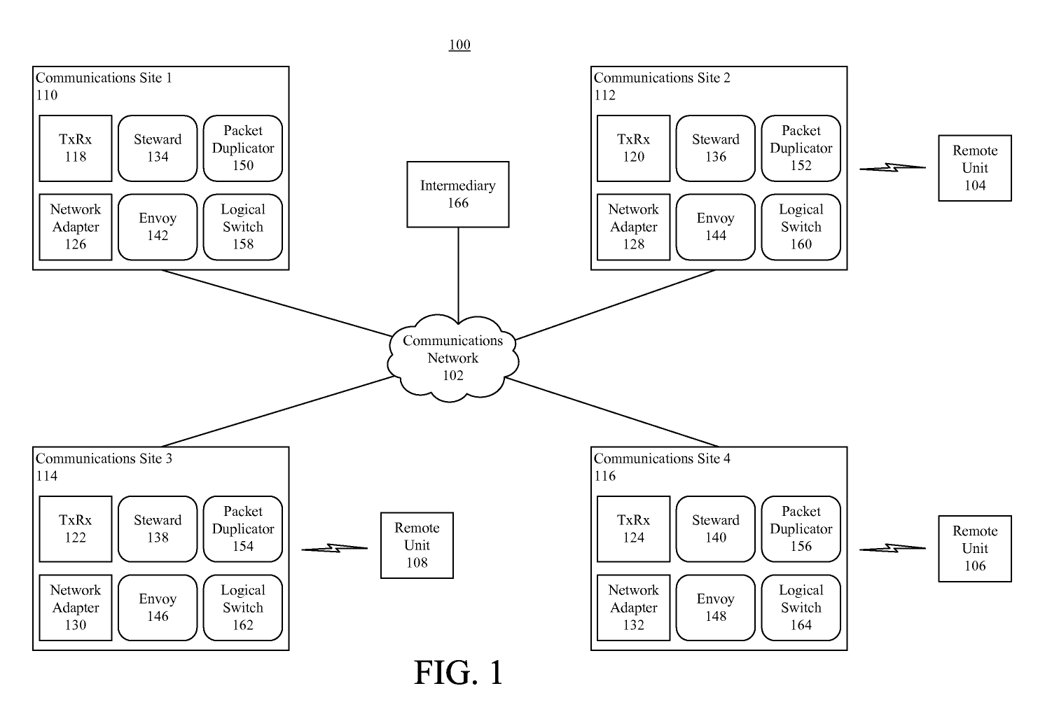

FIG. 1 depicts a communications system 100 that is useful for understanding the present invention. The communications system 100 can include a communications network 102, which may comprise a wide area network (WAN), such as the Internet, the World Wide Web, a dispatch communications network, an interconnect communications network (e.g. a cellular communications network), a public switched telephone network (PSTN), and the like. The communications network also may comprise one or more local area networks (LANs), one or more metropolitan area networks (MANs), and/or any other networks or systems over which communication signals can be propagated. In that regard, the communications network 102 can include wired and/or wireless communication links.

The communications system 100 can include a plurality of remote units 104, 106, 108 which communicate via the communications network 102. The remote units 104-108 can be, for instance, mobile stations (e.g. mobile telephones, mobile radios, mobile computers, personal digital assistants, or the like), computers, wireless gaming devices, access terminals, subscriber stations, user equipment, or any other devices suitably configured to communicate via a wireless communications network. As such, the remote units 104-108 can comprise one or more processors/controllers, transceivers, and/or other suitable components.

In one arrangement, the remote units 104-108 can scale and sum audio information received from a plurality of audio sources (e.g. audio received from a plurality of other remote units during a group call or conference call). In an arrangement in which the remote units 104-108 receive a plurality of video signals, for example during a group call or conference call, the remote units 104-108 can present the video signals independently, for example by presenting each video signal in a different portion of a display or by switching between the video signals.

The remote units 104-108 can access the communications network 102 via communications sites 110, 112, 114, 116. The communications sites 110-116 can communicate among one another via peer-to-peer communications links. As used herein, a “peer-to-peer communications link” is a communications link between peer nodes of a communications network which does not rely on a central call control server for transporting packets between the peer nodes. Because a central call control server and leased communication lines are not required, costs associated with deployment and maintenance of such systems can be avoided. Moreover, with less of a reliance on a centralized infrastructure, network architecture that implements peer-to-peer networking can be very scalable.

The communications sites 110-116 each can include one or more respective transceivers 118, 120, 122, 124 to support communications with the remote units 104-108. The transceivers 118-124 can modulate and demodulate signals to convert signals from one form to another, and can transmit and/or receive such signals over one or more various wireless communication links. In illustration, the transceivers 118-124 can be configured to communicate data via IEEE 802 wireless communications, for example, 802.11 and 802.16 (WiMAX), WPA, or WPA2. In another example, the transceivers 118-124 can communicate data via GSM, TDMA, CDMA, WCDMA, OFDM, or direct wireless communication. Moreover, in one arrangement, one or more of the transceivers 118-124 can communicate with the remote units 104-108 using a personal radio service, for instance in accordance with the guidelines established by the U.S. Federal Communications Commission (FCC) for the General Mobile Radio Service (GMRS) and/or the Family Radio Service (FRS), although the invention is not limited in this regard.

Each of the communications sites 110-116 also can include one or more respective network adapters 126, 128, 130, 132. The network adapters 126-132 can comprise, for example, communications modems, wired and/or wireless transceivers, and/or any other devices that may suitably communicate data over the communications network 102. Via the network adapters 126-132, the communications sites 110-116 can communicate with one another over the communications network 102, for example over peer-to-peer communications links.

Each of the communications sites 110-116 further can include a telecommunications steward (hereinafter “steward”) 134, 136, 138, 140, a telecommunications envoy (hereinafter “envoy”) 142, 144, 146, 148, a packet duplicator 150, 152, 154, 156 and a logical switch 158, 160, 162, 164. The stewards 134-140 can support telecommunications for remote units 104-108 whose home communications sites are the communications sites with which the stewards 134-140 are associated, regardless of where the remote units 104-108 have established network presence. For example, if the communications site 110 is the home communications site for the remote unit 104, the steward 134 can support call processing for the remote unit 104, even while the remote unit 104 is roaming outside the service area of the communications site 110.

Each of the stewards 134-140 can maintain network presence information for their respective remote units 104-108. For example, when the remote unit 104 hands over to, or otherwise establishes network presence at, the communications site 112, information about such event can be communicated to the steward 134. The information can be communicated by the remote unit 104, the communications site 112, or by any other suitable component of the communications system 100. Accordingly, when communications site 110 receives telecommunications content addressed to the remote unit 104, the steward 134 can forward such content to the communications site 112, which can transmit the content to the remote unit 104 via the transceiver 120.

The envoys 142-148 can broker call setup between the remote units 104-108 and the home stewards 134-140 with which the remote units 104-108 are associated. In contrast to the stewards 134-140, the services provided by the envoys 142-148 can be location dependent. That is, the envoy 142 can broker call setup for any remote units 104-108 that establish network presence at the communications site 110, the envoy 144 can broker call setup for any remote units 104-108 that establish network presence at the communications site 112, and the envoy 146 can broker call setup for any remote units 104-108 that establish network presence at the communications site 114, and so on. For instance, if the remote unit 104 has established network presence at the communications site 112 and the remote unit's home site is communications site 110, the envoy 144 can broker call setup between the remote unit 104 and its home steward 134. The envoys 142-148 can broker call setup between the remote units 104-108 and the stewards 134-140 by forwarding call setup information to the stewards 134-140. The call setup information can include, for example, identifiers received from the remote units 104-108 that identify one or more individual call recipients, or a group of call recipients. In the call setup information, the group of call recipients can be represented by a single group identifier or a list of one or more call recipients.

The packet duplicators 150-156 can be tasked with duplicating telecommunication content packets (hereinafter “packets”) that have a plurality of intended recipients, and communicating such packets to the recipients. For example, assume that the remote unit 104 transmits a packet containing telecommunications content and identifies the remote units 106, 108 as intended recipients of the packet. The remote unit 104 can communicate such packet to its home steward 134 (via the transceiver 120 and envoy 144). The steward 134 then can forward the packet and recipient identifiers to the packet duplicator 150. The packet duplicator 150 can duplicate the packet as may be necessary to communicate the packet to each of the remote units 106, 108 identified by the recipient identifiers.

A recipient identifier can be a telephone number, IP address, uniform resource locator (URL), or any other identifier suitable for identifying an intended recipient (e.g. remote unit 108) of the packet. In an arrangement in which the IP address or URL of a recipient's home steward (e.g. home steward 138) is known to the steward 134, the steward 134 also can communicate to the packet duplicator 150 the address of the recipient's home steward, which also can be an IP address, a URL, or any other suitable identifier.

The communications sites 110-116 also can include logical switches 158-164. The logical switches 158-164 can direct data to/from the appropriate resources within the respective communications sites 110-116. For instance, the logical switch 160 can direct data received by the transceiver 120 to the envoy 144. Similarly, the logical switch 160 can direct to the network adapter 128 data that is to be communicated by the communications site 112 over the communications network 102. Moreover, the logical switch 160 can direct data that is communicated among the various components 120, 128, 136, 144, 152 of the communications site 112.

The stewards 134-140, envoys 142-148, packet duplicators 150-156 and logical switches 158-164 can be realized in hardware, software, or a combination of hardware and software. For example, each of the components 134-164 may represent a module, segment, or portion of code, which comprises one or more executable instructions for implementing the specified logical function(s). Further, the components 134-164 can be instantiated in a centralized fashion in one processing system or in a distributed fashion where different elements are spread across several interconnected processing systems. Any kind of processing system or other apparatus adapted for carrying out the methods described herein is suited. Examples of such a processing system can include, but are not limited to, a personal computer, a mobile station, a server, a network appliance, and so on.

The software for implementing the methods described herein can be embedded in a program storage device readable by a machine, tangibly embodying a program of instructions executable by the machine to perform methods and processes described herein. The software also can be embedded in an application product which comprises all the features enabling the implementation of the methods described herein and, which when loaded in a processing system, is able to carry out these methods.

In one arrangement, the communications system 100 can include an intermediary 166. The intermediary 166 can maintain mappings of remote unit identifiers to identifiers for corresponding home stewards 134-140. For example, if the steward 134 is the home steward for the remote unit 104, the intermediary 166 can maintain a mapping of the identifier of the remote unit 104 to the identifier associated with the steward 134. The intermediary 166 also can maintain remote unit grouping information. For instance, the intermediary 166 can maintain mappings of group identifiers to identifiers of remote units contained in the respective groups. The mappings maintained by the intermediary 166 can be stored in one or more text files, data tables, hash tables, or in any other suitable manner.

The intermediary 166 can be accessed or queried by a system which is attempting to establish a communication session with one or more of the remote units 104-108, or groups of the remote units, but does not have prior knowledge of their home communications sites 110-116. Indeed, all initial call requests from such a system can be communicated to the intermediary 166. When the intermediary 166 receives such a request, the intermediary 166 can access the mapping information and forward a request to the appropriate steward 134-140.

Alternatively, the system which is attempting to establish a communication session with one or more of the remote units 104-108 can query the intermediary 166 for addresses or other identifiers that identify the home stewards of the remote units 104-108. For example, the system can communicate identifiers for the remote units 104-108, or one or more group identifiers, to the intermediary 166, and the intermediary 166 can respond with the appropriate remote unit/steward mapping information. If the system communicates one or more remote unit identifiers to the intermediary 166, the intermediary can respond with one or more remote unit identifier/steward mappings. Further, if the system communicates a single group identifier to the intermediary 166, the intermediary can respond with a list of remote unit identifier/steward mappings. The system attempting to establish the communication session then can send requests directly to the home steward 134-140 of the target remote unit 104-108. Queries from a communications site 110-116 that are sent to the intermediary 166 to request the remote unit/steward mapping information can be communicated by the system's steward 134-140 or envoy 142-148.

On the other hand, if a system attempting to establish a communication session with one or more remote units 104-108 has prior knowledge of the remote units' home stewards 134-140 and remote unit group affiliations, such a system need not communicate with the intermediary 166. Indeed, in one aspect of the inventive arrangements, each of the communications sites 110-116 can maintain remote unit to steward and/or remote unit to group mappings for all remote units 104-108 subscribing to the communications system 100.

At this point it should be noted that the components depicted in FIG. 1 illustrate the architecture, functionality, and operation of possible implementations of the communications system 100 according to various embodiments of the present invention. Nonetheless, pursuant to the teachings contained herein, various modifications to the system and components described may become apparent to one skilled in the art. Any systems/components resulting from such modifications are within the intended scope of the present invention.

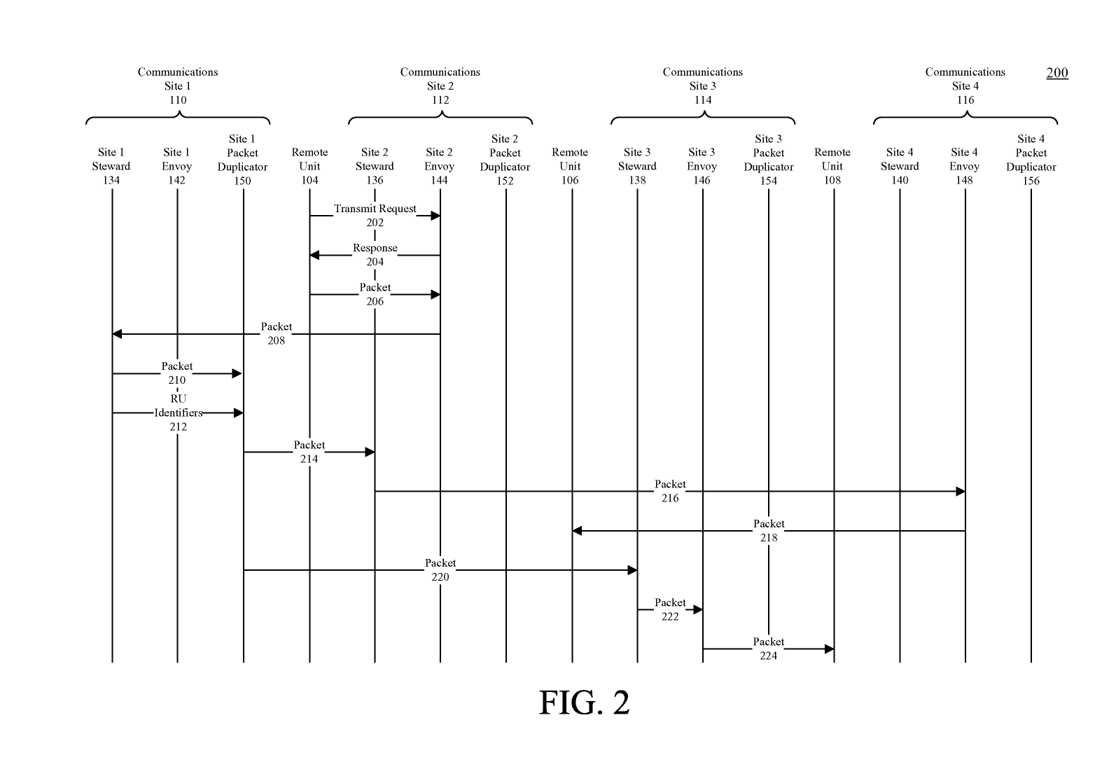

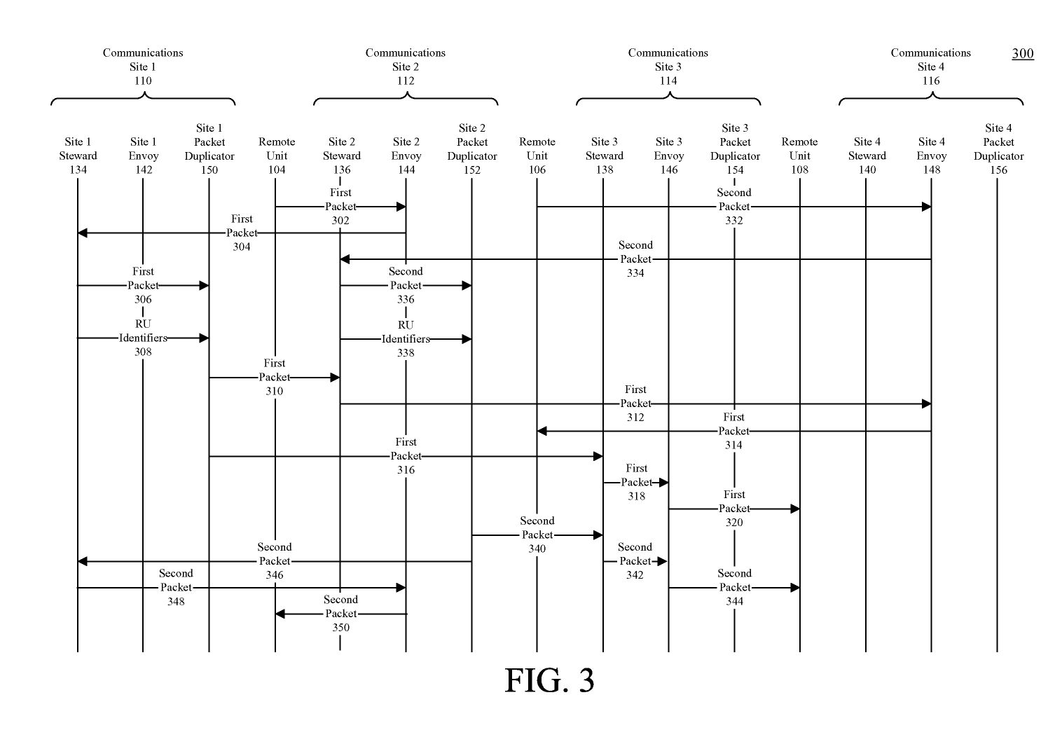

FIG. 2 depicts a half duplex communications signaling flow diagram 200 and FIG. 3 depicts a full duplex communications signaling flow diagram 300, each of which is useful for understanding the present invention. The signaling flow diagrams 200, 300 depict the communication of data among the remote units 104-108, stewards 134-140, envoys 142-148 and packet duplicators 150-156. The transceivers 118-124, network adapters 126-132, communications network 102 and/or other system components can support the communication of such signals, but are not shown in the signaling flow diagram for the purpose of clarity.

For these examples, the signaling flow diagrams 200, 300 can begin with the system in a state in which the remote unit 104, whose home communications site is communications site 110, has established network presence at the communications site 112. Similarly, the remote unit 106, whose home communications site is communications site 112, has established network presence at communications site 116. The remote unit 108 can have network presence established at its home communications site, which is communications site 114. Further, the communications sites 110-116 can be configured to communicate with one another over peer-to-peer communications links.

Referring to the signaling flow diagram 200 of FIG. 2, half duplex communications in accordance with an embodiment of the present invention now will be described. Beginning at step 202, the remote unit 104 can communicate a request to the envoy 144 indicating that the remote unit 104 is preparing to transmit telecommunications content. The request can include an identifier that identifies the remote unit 104. At step 204, the envoy 144 can respond to indicate the envoy is ready to receive the telecommunications content. At step 206, the remote unit 104 can communicate to the envoy 144 a packet comprising the telecommunications content. The packet also can include one or more recipient identifiers or group identifiers that identify the remote units 106, 108 as intended recipients.

At step 208 the envoy can communicate the packet received from the remote unit 104 to the steward 134. The envoy can identify the steward 134 as being the home steward to the remote unit 104 in any suitable manner. For example, the remote unit 104 can communicate to the envoy 144 an identifier associated with the steward 134. Such identifier can be communicated when the remote unit 104 establishes network presence at the communications site 112, when the remote unit 104 communicates the request at step 202, when the remote unit 104 communicates the packet at step 206, or at any other suitable time. In another arrangement, the envoy 144 can identify the steward 134 as the home steward for the remote unit 104 by querying the intermediary 166. For example, the envoy 144 can communicate a query to the intermediary 166 requesting an identifier for the home steward 134 of the remote unit 104. The query can include an identifier associated with the remote unit 104.

From the packet received from the envoy 144, the steward 134 can resolve identifiers for the remote units 106-108 that are the intended recipients of the telecommunications content. For example, if the packet identifies a call group, the steward 134 can identify remote units 106-108 associated with the call group, as well as their home stewards 136-138, by accessing remote unit/group and remote unit/steward mapping information, or by querying the intermediary, as previously described.

Proceeding to step 210, the steward 134 can communicate to the packet duplicator 150 the packet received from the envoy 144. In one arrangement the packet can include recipient identifiers that identify the remote units 106, 108. Alternatively, the recipient identifiers can be communicated from the steward 134 to the packet duplicator at step 212.

Continuing to step 214, the packet duplicator 150 can duplicate the packet and communicate a copy of the packet to the steward 136 that is the home steward of the remote unit 106. Similarly, at step 220 the packet duplicator 150 can communicate a copy of the packet to the steward 138 that is the home steward of the remote unit 108. At step 216, the steward 136 can communicate the packet to the envoy 148 for the communications site 116 where the remote unit 106 has established presence. Likewise, at step 222 the steward 138 can communicate the packet to the envoy 146 for the communications site 114 where the remote unit 106 has established presence. At step 218, the envoy 148 can communicate the packet to the remote unit 106, and at step 224 the envoy 146 can communicate the packet to the remote unit 108.

Referring now to the signaling flow diagram 300 of FIG. 3, full duplex communications in accordance with an embodiment of the present invention will be described. Beginning at step 302, the first remote unit 104 can communicate to the envoy 144 a packet comprising telecommunications content (first packet). The first packet also can include recipient identifiers that identify the remote units 106, 108 as intended recipients. Further, at step 332 the remote unit 106 can communicate to the envoy 148 another packet comprising telecommunications content (second packet). The second packet also can include recipient identifiers that identify the remote units 104, 108 as intended recipients. Because such communications are performed in a full duplex communications system, the first and second packets can be sent simultaneously, substantially simultaneously, or at different times during a group call or conference call.

For the purpose of clarity, the following description first describes the signal flow of the first packet and then describes the signal flow of the second packet. Nonetheless, such signal flows are not limited to the order in which they are described and may occur out of the order noted in the figures. For example, two signals shown in succession may, in fact, be communicated substantially concurrently, depending upon the functionality involved. Moreover, communication of the second packet to its intended recipients may actually occur prior to communication of the first packet to its intended recipients.

Continuing from step 302 to step 304, the envoy 144 can communicate the first packet to the home steward 134 of the remote unit 104. As noted, the envoy 144 can identify the steward 134 as being the home steward to the remote unit 104 in any suitable manner. From the packet received from the envoy 144, the steward 134 can resolve identifiers for the remote units 106-108 that are the intended recipients of the telecommunications content. For example, if the packet identifies a call group, the steward 134 can identify remote units 106-108 associated with the call group, as well as their home stewards 136-138, by accessing remote unit/group and remote unit/steward mapping information, or by querying the intermediary, as previously described.

Proceeding to step 306, the steward 134 can communicate to the packet duplicator 150 the first packet received from the envoy 144. In one arrangement the packet can include recipient identifiers that identify the remote units 106, 108. Alternatively, the remote unit identifiers of the intended recipients 106, 108 can be communicated to the packet duplicator at step 308. Identifiers for corresponding home stewards 136-138 also can be communicated from the steward 134 to the packet duplicator 150 at step 308.

Continuing to step 310, the packet duplicator 150 can duplicate the first packet and communicate a copy of the first packet to the steward 136 that is the home steward of the remote unit 106. At step 312, the steward 136 can communicate the first packet to the envoy 148 for the communications site 116 where the remote unit 106 has established presence. Proceeding to step 314, the envoy 148 can communicate the first packet to the remote unit 106.

At step 316 the packet duplicator 150 also can communicate a copy of the first packet to the steward 138 that is the home steward of the remote unit 108. Continuing to step 318, the steward 138 can communicate the first packet to the envoy 146 for the communications site 114 where the remote unit 106 has established presence, and at step 320 the envoy 146 can communicate the first packet to the remote unit 108.

Referring now to the communication of the second packet and continuing from step 332 to step 334, the envoy 148 can communicate the second packet to the home steward 136 of the remote unit 106. As noted, the envoy 148 can identify the steward 136 as being the home steward to the remote unit 106 in any suitable manner. From the packet received from the envoy 148, the steward 136 can resolve identifiers for the remote units 104, 108 that are the intended recipients of the telecommunications content. For example, if the packet identifies a call group, the steward 134 can identify remote units 106-108 associated with the call group, as well as their home stewards 136-138, by accessing remote unit/group and remote unit/steward mapping information, or by querying the intermediary, as previously described.

Proceeding to step 336, the steward 136 can communicate to the packet duplicator 152 the second packet received from the envoy 148. Recipient identifiers identifying the remote units 104, 108 also can be communicated in the second packet or communicated separately at step 338. In an arrangement in which the steward 136 has or retrieves additional address information for the intended recipients 104, 108, for example the address of their home stewards 134, 138, at step 338 the steward 136 also can communicate such information to the packet duplicator 152.

Continuing to step 340, the packet duplicator 152 can duplicate the second packet and communicate a copy of the second packet to the steward 138 that is the home steward of the remote unit 108. At step 342, the steward 138 can communicate the second packet to the envoy 146 for the communications site 114 where the remote unit 108 has established presence. Proceeding to step 344, the envoy 146 can communicate the second packet to the remote unit 108.

At step 346 the packet duplicator 152 also can communicate a copy of the second packet to the steward 134 that is the home steward of the remote unit 104. Continuing to step 348, the steward 134 can communicate the second packet to the envoy 144 for the communications site 112 where the remote unit 104 has established presence, and at step 350 the envoy 144 can communicate the second packet to the remote unit 104.

As used herein, the term “telecommunications content” refers to content that may be communicated during a call session. Such content can include, audio content, video content, multimedia content, text, or any other information that may be communicated during the call session. Further, the call session can be a dispatch call session (e.g. half duplex) or an interconnect call session (e.g. full duplex).

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for supporting telecommunications over a wide area network, comprising:
receiving telecommunications content and a group identifier from a first remote unit;
from the group identifier, identifying a plurality of recipient identifiers;
communicating to a packet duplicator the telecommunications content and the plurality of recipient identifiers, each of the recipient identifiers being associated with at least one intended recipient of the telecommunications content; and
via at least one peer-to-peer communications link, communicating the telecommunications content to a plurality of telecommunications stewards, each of the telecommunications stewards being associated with at least one respective recipient identified by at least one of the recipient identifiers.

2. The method of claim 1, further comprising:
identifying the plurality of telecommunications stewards associated with the recipients; and
for each of the telecommunications stewards, communicating to the packet duplicator a steward identifier.

3. The method of claim 1, wherein receiving the telecommunications content comprises receiving the telecommunications content at a first telecommunications steward associated with the first remote unit.

4. The method of claim 3, wherein receiving the telecommunications content from the first remote unit comprises receiving the telecommunications content via a telecommunications envoy.

5. The method of claim 1, wherein receiving the telecommunications content from the first remote unit comprises:
at a first communications site that is a home communications site for the first remote unit, receiving the telecommunications content via a telecommunications envoy that is associated with a second communications site.

6. The method of claim 5, wherein receiving the telecommunications content comprises receiving the telecommunications content at a first telecommunications steward associated with the first remote unit.

7. The method of claim 1, further comprising querying an intermediary to identify the plurality of telecommunications stewards.

8. The method of claim 7, wherein querying the intermediary comprises communicating the plurality of recipient identifiers to the intermediary.

9. A method for supporting telecommunications over a wide area network, comprising:
at a telecommunications steward associated with a second communications site, receiving telecommunications content and an identifier associated with a second remote unit from a first communications site, the telecommunications content being generated by a first remote unit;
identifying a third communications site at which a second remote unit has established its presence;
via at least one peer-to-peer communications link, forwarding the telecommunications content and the identifier to a telecommunications envoy associated with the third communications site.

10. The method of claim 9, wherein receiving the telecommunications content comprises receiving the telecommunications content from a packet duplicator associated with the first communications site.

11. The method of claim 9, further comprising:
parsing a communications packet comprising the telecommunications content and identifying the identifier associated with the second remote unit; and
processing the identifier to identify the third communications site.

12. A system that supports telecommunications over a wide area network, comprising:
a first telecommunications steward that receives telecommunications content and a group identifier from a first remote unit; and
a packet duplicator to which the first telecommunications steward communicates the telecommunications content and the plurality of recipient identifiers, the packet duplicator forwarding the telecommunications content via at least one peer-to-peer communications link to a plurality of additional telecommunications stewards, each of which are associated with at least one respective recipient identified by at least one of the recipient identifiers.

13. The system of claim 12, wherein:
the first telecommunications steward identifies the plurality of telecommunications stewards associated with the recipients; and
for each of the telecommunications stewards, the first telecommunications steward communicates to the packet duplicator a steward identifier.

14. The system of claim 12, wherein the telecommunications content is received via a telecommunications envoy.

15. The system of claim 12, wherein the telecommunications envoy is associated with a second communications site.

16. The system of claim 12, wherein the telecommunications content is received via half duplex communications.

17. The system of claim 12, wherein the telecommunications content is received via full duplex communications.

18. A program storage device readable by a machine, tangibly embodying a program of instructions executable by the machine to perform method steps for supporting telecommunications over a wide area network, said method steps comprising:
receiving telecommunications content and a group identifier from a first remote unit;
from the group identifier, identifying a plurality of recipient identifiers;
communicating to a packet duplicator the telecommunications content and the plurality of recipient identifiers, each of the recipient identifiers being associated with at least one intended recipient of the telecommunications content; and
via at least one peer-to-peer communications link, communicating the telecommunications content to a plurality of telecommunications stewards, each of the telecommunications stewards being associated with at least one respective recipient identified by at least one of the recipient identifiers.

19. The program storage device of claim 18, said method steps further comprising:
identifying the plurality of telecommunications stewards associated with the recipients; and
for each of the telecommunications stewards, communicating to the packet duplicator a steward identifier.

20. The program storage device of claim 18, wherein receiving the telecommunications content comprises receiving the telecommunications content at a first telecommunications steward associated with the first remote unit.
